(19) United States
(12) Patent Application Publication
(10) Pub. No.: US 2004/0245734 A1
(43) Pub. Date: Dec. 9, 2004

(54) Mobile cleaning bucket caddy

(76) Inventor: William Thomas, Oakland, CA (US)

Correspondence Address: William Thomas, Station D, PO Box 70303, Oakland, CA, 94612, US

(21) Appl. No.: 10/452,960

(22) Filed: Jun. 4, 2003

(51) Int. Cl. B62B 1/00

(52) U.S. Cl. 280/47.26

(57) ABSTRACT

The Cleaning Industry has long needed a compact piece of equipment that would carry numerous Cleaning Hand Tools and Chemicals directly to the job site. Presently, the Janitor or Maid Carts are to large to enter most cleaning work areas. Much time is lost going back and forth to get Hand Tools and Chemicals from the large Maid Carts outside the door to Restrooms, Offices, Hospital Patients Rooms, etc. The Mobile Cleaning Caddy allow the Professional Cleaners the ability to have at their finger-tip the type of Cleaning Hand Tools and Chemicals necessary to complete any Cleaning Assignment in minimum time. The Mobile Cleaning Caddy allow you to complete Window Washing, Wall Washing, Restroom Cleaning, Office Cleaning, Hospital Patient Rooms, Commerical Kitchens and Eating Areas, High and Low Dusting, Lighting Tube Replacement, Carpet Spot and Stain Removal the ability to carry necessary Cleaning Hand Tools and Chemicals. It will easily fit through any door without the worry of scratching doors and door frames.

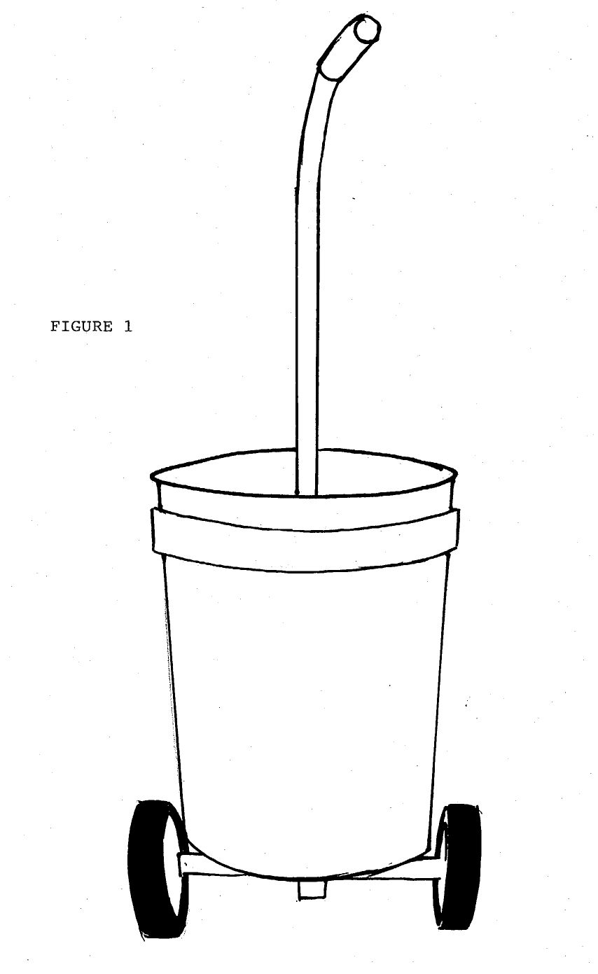

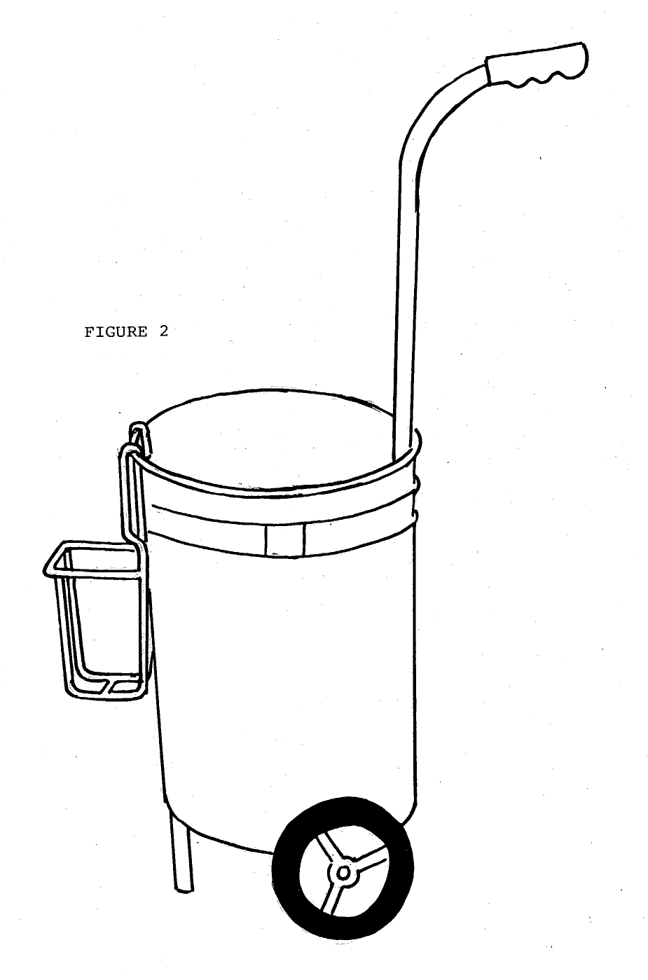

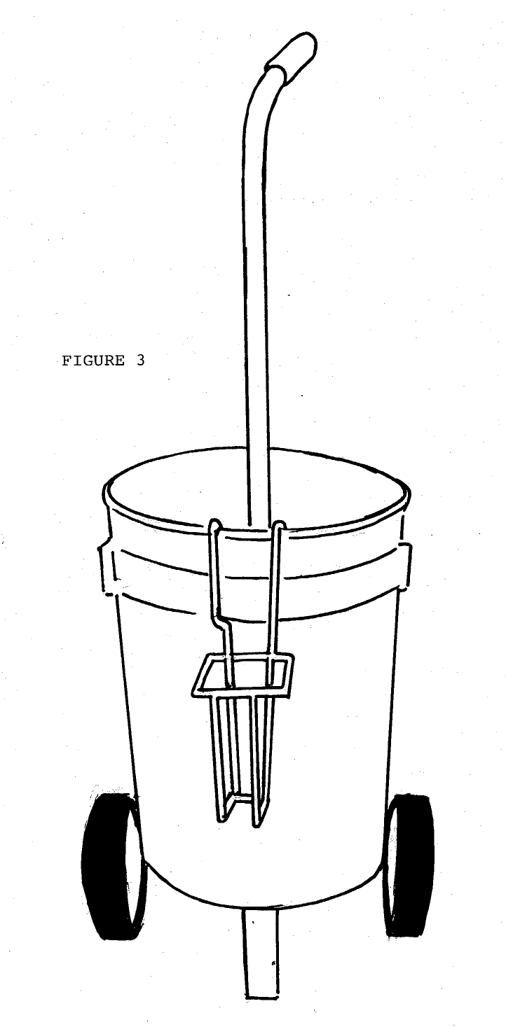

When you look in the current Cleaning and Maintenance Trade Magazines, you will find the standard Floor Machines (buffers), Carpet Cleaners, Mop Buckets, etc. While the above mention Cleaning Equipment has advanced in appearance and technology, the Industry has overlooked the need for many Cleaning tools that would be used daily, and would eliminate many cleaning problems that presently exist. Cleaning Management primatily relies on the advice of Cleaning Supply Salespersons, their personnel turnover is almost monthly. With the business mergers in this Industry, the Cleaning Professional is left to devise their own Cleaning Methods and Techniques. In today's Cleaning World, the average School Custodian is assigned (20) classrooms, (4) or more large Restrooms, Showers, Educators offices, etc., to clean in an (8) hour period. Just (7) years ago, this amount of work was assigned to (2) full time cleaners and (1) part-time cleaner. Contract Cleaning Personnel are cleaning upwards of 30,000 sq. ft. of Office and Restroom space daily in private buildings. Hospital Cleaners have almost doubled their cleaning per square feet. With this large workload, Professional Cleaners spend a sizeable amount of time going back and forth getting Hand Tools, Cleaning Products for different cleaning jobs from Janitor and Maid Carts. Presently the Janitor and Maid Carts are so large that they leave them outside of the door.

This system not only waste time, but Professional Cleaners will tell you that they leave various Cleaning Tools and Products behind due to the pressure of cleaning time given them by Cleaning Management, thus wasting more time going back to get the left behind tools and cleaning chemicals. Example: Imagine a large Cleaning Cart outside a Restroom Door where the Cleaner will have to run back and forth to get toilet bowl and urinal Cleaning Tools and Chemicals, take them back to the Cleaning Cart outside of the door or risk forgetting them when they start cleaning mirrors, spotting walls and doors which take different tools and cleaning chemicals. What about dusting ceiling vents, ledges, window sills, partitions, light fixtures to mention a few cleaning duties. You then must go back to the Cleaning Cart outside of the door to get hand tools and cleaning chemicals to clean the face sink, plumbing fixtures. If you are in an office area with many desks, a large Cleaning Cart is not feasible to bring inside. You will need dusting tools for office machines, furniture, lights, window sills, also furniture polish for desk, etc. General Purpose Cleaner for finger prints and marks, to mention a few Cleaning Duties. The same will go for a Hospital Patient Room where you may have to strip the bed, clean and disinfect it, same for lights, furniture, restroom, call buttons, etc. It does not matter what Cleaning Environment, the ability to have the necessary Cleaning Tools and Chemicals at your finger tips is most important. Its time management at its best. Cleaning Organization start with the necessary tools, cleaning chemicals and technical knowledge. Many Cleaning Operations lose thousands of man-hours simply due to poor Cleaning Opganization. With (35) continuous years of Cleaning experience, Training thousands of people how to clean. Authored (16) books on Cleaning Maintenance, Patent Pending on several other Cleaning Products, I have designed and developed a Mobile Cleaning Caddy on wheels with handle that is:

1. Only 12″ wide, 14″ high.

2. Can hold (26) Cleaning Tools and Cleaning Chemicals that are used by Millions of Professional Cleaners each and every day.

3. Will easily move through doorways and not have to worry about scratching doors and doorframes.

4. Will easily move between office desks carrying Cleaning Tools and Cleaning Chemicals that are needed to complete daily cleaning duties.

5. Have well designed “Hang-On Baskets ” which will allow additional cleaning supplies such as Furniture polish, Grafffiti remover, Insect Spray, Powder Cleaner such as Comet, etc.

6. Need only a 12″×12″ space for storage.

By carrying (26) cleaning tools and chemicals, the Professional Custodian can quickly move from cleaning a sink to cleaning a mirror and wall area, from cleaning the toilet bowl, the plumbing fixtures, to partition cleaning. Spot cleaning walls, doors, around the light switches, removing graffiti marks without having to run back and forth to an overloaded cleaning cart outside of the restroom, office or hospital patient door. If the Professional Cleaner run into a stain or mark on any surface, they have the necessary cleaning tools and chemicals to take care of the job. Professional Cleaners will tell you that they have long needed a small efficient mobile unit to carry necessary cleaning chemicals and tools directly to the job, saving valuable time, energy and frustration. This Mobile Cleaning Caddy will allow the Professional Custodian the ability to choose the Cleaning Chemicals and Tools necessary to complete the cleaning job in minumum time. The following list of common chemicals and hand tools are used by Professional Custodians on a daily basis:

1. Triple-Headed Toilet Bowl Mop (white handles) used to quickly clean sinks, wall area around sinks, etc.

2. Triple-Headed Toilet Bowl Mop (Color Handles) used to quickly clean and disinfect toilet bowl, toilet seats, urinals.

3. Window Strip Washer—will wash mirrors and windows in half the time.

4. Window Squeegee—will quickly squeegee water from mirrors and windows.

5. Janitor Tweezers—used to remove feminine hygine products from dispensers, unsanitary items from floors, urinals, toilet bowls, waste baskets, etc.

6. Water Hose—specially designed water hose, allow Custodian to draw water from any sink.

7. Razor Blade Scraper—used for many cleaning jobs such as, removing tape from window glass, etc.

8. Putty Knife—aid in removing floor wax build-up along floor edges, corners, gum from floors, etc.

9. Rubber Gloves—Safety first, used when cleaning toilet bowls, urinals, sinks, wall washing, etc.

10. Hand Scrubber with Pad—used to scrub stubborn spots and stains on floors, walls, sinks, etc.

11. Hand Scrubber Handle—used for Hand Scrubber.

12. Moss Squeegee—Used to squeegee water solution from walls, floors, etc., reduce time.

13. Door Stop—used to prop open doors for quick access when cleaning.

14. Cleaner-Disinfectant—used to clean and disinfect toilet bowls, urinals, sinks, hospital rooms, etc.

15. Windex Glass Cleaner—used to clean and polish plumbing fixtures, small mirrors, windows, door glass, new face sink surfaces, etc.

16. Furniture Polish—used to clean and polish furniture, fights building sick syndrome by removing dust, etc.

17. Graffiti Remover—used to remove graffiti from any surface.

18. Insect Spray—used to spray for ants, roaches, crickets, silverfish, sowbugs, spiders, fleas, etc.

19. Powder Cleaners—such as (Comet) use to clean worn sink surfaces, other stubborn stains, etc.

20. Toilet Bowl Plunger—used to unplug clogged toilet bowls, sinks, etc.

21. Feather Duster—used to dust desks, file cabinets, window sills, bookcases, etc.

22. Split-Duster—has cotton head, used to dust conference tables, chairs, doors, walls, light fixtures.

23. Safety Eye Goggles—for safety when pouring cleaning chemicals, blowing dust, etc.

24. Custodial Hand Clamp—hold any cleaning tool, such as gloves, cleaning brushes, rags, etc.

25. Gong Brush—with 18″ handle, used to brush upholstery furniture, carpet edges, corners, under ledges, between office furniture, etc.

26. General Purpose Cleaner—spot cleaning walls, floors, etc.

Remove the cleaning tools, chemicals and the “Hang On Baskets,” you now have a Window and Wall Washing Bucket on wheels, no more lifting buckets of Cleaning Solution, save on your back.

1. I claim that the Mobile Cleaning Bucket Caddy will greatly reduce the cleaning time through its compact size, its ability to carry over (30) Cleaning Hand Tools and Chemicals directly to the job and have them at your finger tip. Its adaptibility to all types of Cleaning Duties including large and small Restrooms, Showers, Locker Rooms, Offices, Commerical Kitchen Cleaning, Mobile Wall and Window Washing, High and Low Dusting, Hospital Patient Rooms, etc.

2. I claim that there is no other Cleaning Product presently on the market of this size that will produce cleaning results, carry Cleaning Hand Tools and Chemicals as the Mobile Cleaning Bucket Caddy.
